(19) United States
(12) Patent Application Publication
(10) Pub. No.: US 2023/0356029 A1
(43) Pub. Date: Nov. 9, 2023

(54) SYSTEM FOR AUTOMATIC EQUIPMENT ID AND PERFORMANCE EVALUATION AND RELATED METHODS

(71) Applicant: TruGolf, Inc., Centerville, UT (US)

(72) Inventors: Nathan E. Larsen, Alpine, UT (US); Steven Perry, Lehi, UT (US)

(21) Appl. No.: 17/735,886

(22) Filed: May 3, 2022

(51) Int. Cl. A63B 24/00; A63B 67/02; A63B 69/36; A63B 71/06; H04N 5/33

(52) U.S. Cl. CPC A63B 24/0021; A63B 67/02; A63B 69/3605; A63B 69/3623; A63B 69/3658; A63B 71/0622; H04N 5/33; A63B 2024/0034; A63B 2024/0056; A63B 2071/0636; A63B 2071/0638; A63B 2220/806

(57) ABSTRACT

A sports simulator may include a piece of sports equipment bearing a marking that is configured to at least partially identify the piece of sports equipment, a first sensor configured to automatically detect the marking and a second sensor configured to detect a trajectory of a ball, and a display configured to display a sports simulation. The sports simulator may also receive an identification of the marking, identify a characteristic of a piece of sports equipment associated with the marking, receive the trajectory of the ball, generate simulation data indicative of a virtual ball with a virtual flight path responsive to the trajectory, store the characteristic of the piece of sports equipment in association with the virtual flight path of the virtual ball, and cause the display to display the virtual flight path of the virtual ball in the sports simulation.

### BACKGROUND

Golf simulators are used to simulate physical golf play in an at least partially virtual environment. In some golf simulators, a person using the simulator physically swings a golf club at a golf ball, strikes the golf ball, and then observes a simulated golf ball on a virtual golf course. Such simulators are, for example, incorporated into video games and training systems.

### BRIEF SUMMARY

In some embodiments, a sports simulator may include a piece of sports equipment bearing a marking that is configured to at least partially identify the piece of sports equipment. The sports simulator may also include a first sensor configured to automatically detect the marking and a second sensor configured to detect a trajectory of a ball as well as a display configured to display a sports simulation. The sports simulator may also include a processor and a computer-readable storage medium which stores instructions that, when executed by the processor cause the sports simulator to receive an identification of the marking responsive to the first sensor detecting the marking. The instructions may cause the sports simulator to identify a characteristic of a piece of sports equipment associated with the marking in a database responsive to receiving the identification of the marking. The instructions may cause the sports simulator to receive the trajectory of the ball from the second sensor responsive to the second sensor detecting use of the piece of sports equipment to interact with the ball. The instructions may cause the sports simulator to generate simulation data indicative of a virtual ball with a virtual flight path responsive to receiving the trajectory. The instructions may cause the sports simulator to store the characteristic of the piece of sports equipment in association with the virtual flight path of the virtual ball, and cause the display to display the virtual flight path of the virtual ball in the sports simulation.

A method for simulating sports equipment performance may involve detecting a marking on a piece of sports equipment utilizing a first sensor and identifying a characteristic of the piece of sports equipment responsive to detecting the marking. A trajectory of a ball may be detected responsive to use of the piece of sports equipment utilizing a second sensor and simulation data indicative of a virtual ball with a virtual flight path may be generated responsive to the trajectory. The characteristic of the piece of sports equipment may be stored in association with the virtual flight path of the virtual ball, and a display may be caused to display the virtual flight path of the virtual ball in the sports.

### BRIEF DESCRIPTION OF THE SEVERAL VIEWS OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a perspective view of an example sports simulator system in the form of a golf simulator system.

FIG. 2A depicts an example piece of sports equipment in the form of a golf club having a marking configured to identify the golf club.

FIG. 2B shows yet another example piece of sports equipment in the form of a golf ball.

FIG. 3 illustrates possible configurations for a marking on a piece of sports equipment, such as golf club.

FIG. 4 depicts non-limiting examples of potential sports equipment for use in a sports simulator system including a baseball mitt, baseball bat, tennis racket, golfing glove, and golfing shoe.

FIG. 5 depicts non-limiting examples of potential marks for use on pieces of sports equipment in a sports simulator system including a QR code, a reflective infrared (IR) signature, and a dot IR signature.

FIG. 6 is a flowchart illustrating an operation of the sports simulator system performed by a processor executing instructions stored on a computer-readable storage medium.

FIG. 7 is a flowchart illustrating a method for simulating sports equipment performance.

FIG. 8 is a block diagram of an electronic system included in one or more systems of this disclosure.

### DETAILED DESCRIPTION

In the following detailed description, reference is made to the accompanying drawings, which form a part hereof, and in which are shown, by way of illustration, specific examples of non-limiting examples in which this disclosure may be practiced. These examples are described in sufficient detail to enable a person of ordinary skill in the art to practice this disclosure. However, other examples enabled herein may be utilized, and structural, material, and process changes may be made without departing from the scope of the disclosure.

Sports simulators often function to provide a user with an artificial re-creation of a sports activity. In some cases, sports simulators may offer a more accessible or more convenient way to participate in a given sports activity without having access to all of the necessary equipment or facilities for a given sport. For example, in some cases sports simulators may adapt a sport that is typically confined to outdoor venues to be able to be played within much smaller space requirements, such as within one's own home. Additionally, some simulators enable using equipment that would typically be used when playing the sport in a non-simulation environment. Capturing accurate equipment information utilizing a sports simulator may be difficult as reliance on user entry is undependable and unverifiable, equipment does not bear capturable identifying markings, and previous attempts to guess what equipment is being used based on performance is often inaccurate. Thus, the ability of conventional simulators to provide accurate representations of player and equipment performance often falls short as conventional simulators do not have a reliable way to incorporate properties of physical equipment of a user into the simulation.

In accordance with this disclosure, a sports simulator may be capable of automatically identifying characteristics of a piece of sports equipment. In some embodiments the sports simulator automatically detects at least one marking on a piece of sports equipment and identifies at least one characteristic of the piece of sports equipment responsive to detecting the marking. The simulator may detect and collect data of uses or actions of the piece of sports equipment by a user and may associate the detected characteristics of the sports equipment with the data collected from the uses or actions of the pieces of sports equipment and store the associated data in a database. Tracking of player and equipment performance may enable more detailed and accurate performance representation, evaluation, and improvement without being required to rely on unreliable user entry or inaccurate guessing techniques. Moreover, the sports simulator may use the data collected from the characteristics of the sports equipment as well as the data from the uses of the pieces of sports equipment to generate recommendations to a user to improve their play and to improve the overall gameplay experience. Furthermore, the sports simulator may use the data collected from the characteristics of the sports equipment to reflect those characteristics in a virtual environment, thus allowing for greater immersion and more accurate simulation of the sport being simulated.

As used herein, the terms “computer-readable storage medium” and “memory device” mean and include microelectronic devices exhibiting, but not limited to, memory functionality, but exclude embodiments encompassing transitory signals. For example, a system on a chip (SoC) is encompassed in the meaning of computer-readable storage medium. By way of non-limiting examples, computer-readable storage media may generally include packaged semiconductor devices having memory functionality and storing instructions for operating sports simulators as described herein, unless otherwise specified. More specific examples of memory devices include spin torque transfer magnetic random access memory (STT-MRAM), magnetic random access memory (MRAM), dynamic random access memory (DRAM) (e.g., synchronous DRAM (SDRAM) conforming with a double data rate (DDR) and/or graphics DDR (GDDR) standard (DDR4, DDR5, DDR6)), static random access memory (SRAM), racetrack memory, read-only memory (ROM) such as an EPROM, resistive read-only memory (RROM), flash memory, and other known memory types.

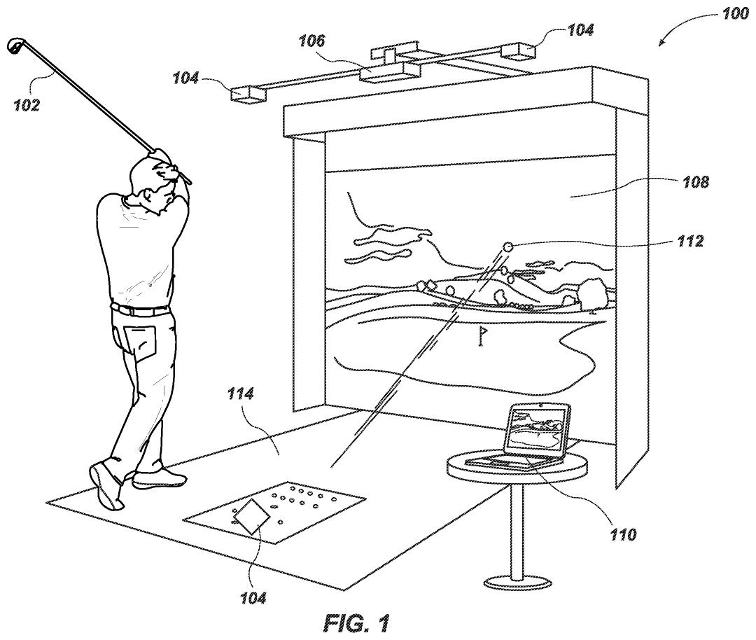

FIG. 1 is a perspective view of an example sports simulator system 100 in the form of a golf simulator system. The sports simulator system 100 may include a piece of sports equipment 102 (e.g., a golf club), the piece of sports equipment 102 bearing a marking configured to at least partially identify the piece of sports equipment. The sports simulator system 100 may also include at least one of a first sensor 104 that is configured to detect the marking on a piece of sports equipment 102 (e.g., a golf club), enabling the sports simulator system 100 to automatically identify the piece of sports equipment 102 and/or its characteristics responsive to detecting the marking on the piece of sports equipment 102. Sports simulator system 100 may also include a ball 112 bearing another marking that is configured to at least partially identify the ball 112. The sports simulator system 100 may also include at least one of a second sensor 106 that is configured to detect a trajectory of a ball 112 (e.g., a golf ball). The sports simulator system 100 may also include a display 108 which may be operably coupled to a computer 110 where the computer 110 may include a processor and a computer-readable storage medium storing executable instructions. The display 108 may be configured to display a sports simulation. In one embodiment, the display 108 may include a projector configured to project images onto a screen. In some embodiments, the sports simulator system 100 may also optionally include an enclosure.

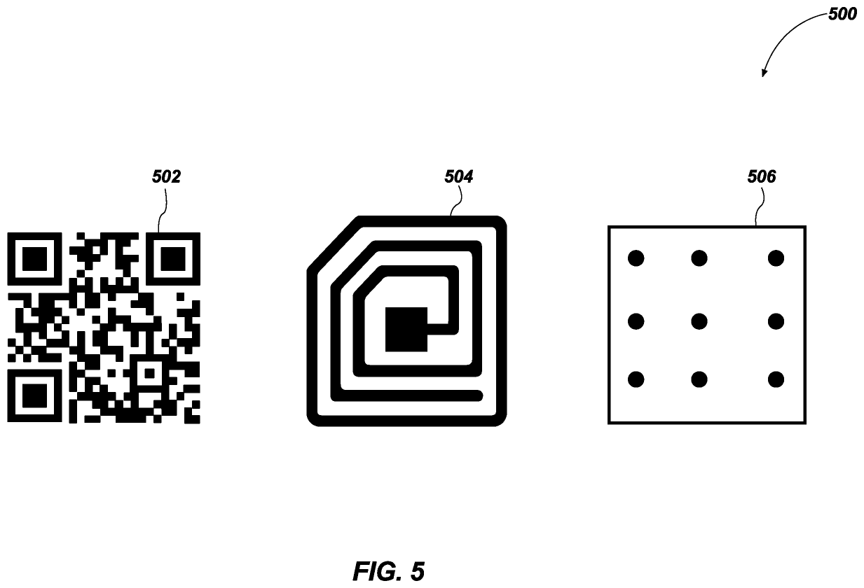

First sensor 104 may, in some embodiments, be in the form of a camera that is configured to automatically detect a marking (discussed in more detail below with regard to FIG. 5) on a piece of sports equipment. In some embodiments, first sensor 104 may include an infrared (IR) camera capable of detecting IR radiation. First sensor 104 may be positioned on the sports simulator system 100 such that the sports equipment 102 will be in view while a user plays a simulated sport in the play area 114. More specifically, the first sensor 104 may be positioned to detect a portion of the sports equipment 102 bearing the marking while, for example, the user engages in a simulated sport activity in the play area 114. In some embodiments, first sensor 104 may be mounted on a support structure extending over the play area 114. In other embodiments, first sensor 104 may be located anywhere such that the sports equipment 102 will be in view while a user plays a simulated sport in the play area 114. For example, first sensor 104 may be positioned on or under play area 114, with first sensor 104 exposed to detect the sports equipment 102 on or above play area 114, such that a portion of the sports equipment 102 bearing a marking will be detectable by the first sensor 102 while a user plays a simulated sport in the play area 114. Such a position and orientation for the first sensor 104 may enable detection of a marking on the bottom of a golf club head or on the backside of a golf club face in examples where the sports equipment 102 is configured as a golf club. For instance, first sensor 104 may be located in front of, behind, above, beneath, to one horizontal side, or to an opposite horizontal side of where a piece of sports equipment 102 will be while a user plays a simulated sport in the play area 114.

In some embodiments, first sensor 104 may always be powered on, however in some embodiments, first sensor 104 may pulse or only power on during specified phases of play such as, for example, when setting up or initiating a game or for a specified period of time after powering on the sports simulator system 100. First sensor 104 and/or computer 110 may be configured to perform image recognition to detect markings on a piece of sports equipment 102 such as, for example, milled, stamped, engraved, scribed, inked (including infrared inked), and/or adhered markings on the piece of sports equipment 102. In some embodiments, sports simulator system 100 may also be configured to identify a piece of sports equipment 102 responsive to the first sensor 104 detecting a physical shape of the piece of sports equipment 102. First sensor 104 may be configured to automatically detect a logo imprinted onto the piece of sports equipment. In some embodiments, first sensor 104 may be configured to automatically detect physical surface detail on a piece of sports equipment. For example, first sensor 104 may be configured to detect a dimple pattern on the surface of a golf ball. First sensor 104 may be positioned on the play area 114.

Second sensor 106 may be a sensor configured to detect a trajectory of a ball 112. In some embodiments, second sensor 106 may include a high-speed camera that, upon detecting a sports equipment action or use, captures the action or use by acquiring a series of images using very brief exposures. For example, in some embodiments, the second sensor 106 may capture image data at exposures less than or equal to 1/1000 of a second or with a frame capture rate greater than or equal to 250 frames per second (FPS). In some embodiments, second sensor 106 may have a capture rate in a range extending from about 2500 FPS to about 3000 FPS. In some embodiments, second sensor 106 may be configured to capture an interaction between a ball (e.g., ball 112) and a piece of sports equipment (e.g., sports equipment 102). Second sensor 106 may be configured to detect the movement of a ball such as its speed, acceleration, trajectory, spin, deformation, or any combination or subcombination of these. In certain embodiments where the piece of sports equipment 102 is a golf club and the ball 112 is a golf ball, the second sensor 106 may be configured to detect at least one of club head speed, ball flight trajectory, ball travel distance, club face angle, ball flight velocity, ball flight acceleration, or ball deformation. Furthermore, second sensor 106 may include a memory device to store captured images. For example, in some embodiments, second sensor 106 may be configured to capture image data for a predefined period of time such as the entirety of a detected use or action of a piece of sports equipment. The second sensor 106 may be configured to store all images associated with that period of time in memory. The memory device may be accessible by a processor of the sports simulator system 100 for analysis.

In some embodiments, first sensor 104 and second sensor 106 may be combined into a single sensor, a single housing, and/or a single device. For example, first sensor 104 and second sensor 106 may be the same sensor of a camera where the camera may be used both for capturing an interaction between a ball (e.g., ball 112) and a piece of sports equipment (e.g., sports equipment 102) as well as being configured to detect a marking on the piece of sports equipment (e.g., sports equipment 102). In other embodiments, first sensor 104 and second sensor 106 may be two separate sensors, located in two distinct housings, and/or be provided in two separate devices. For example, the first sensor 104 may be located in a first camera and the second sensor 106 may be located in a second camera, where the second camera is configured to capture an interaction between a ball (e.g., ball 112) and a piece of sports equipment (e.g., sports equipment 102) and the first camera is configured to detect a marking on the piece of sports equipment (e.g., sports equipment 102). In some embodiments, first sensor 104 and second sensor 106 may be implemented in two separate cameras where each camera may be configured to be used both for capturing an interaction between a ball (e.g., ball 112) and a piece of sports equipment (e.g., sports equipment 102) as well as being configured to detect a marking on the piece of sports equipment (e.g., sports equipment 102).

In some embodiments, the sports simulator system 100 may include two separate systems. For example, the two systems may include a first system that may be configured to perform the simulation of a selected sport and a separate second system that may be configured to perform analysis and identification of a piece of sports equipment (e.g., sports equipment 102). In this example, the first and second systems may be configured to communicate with each other, e.g., through sharing data.

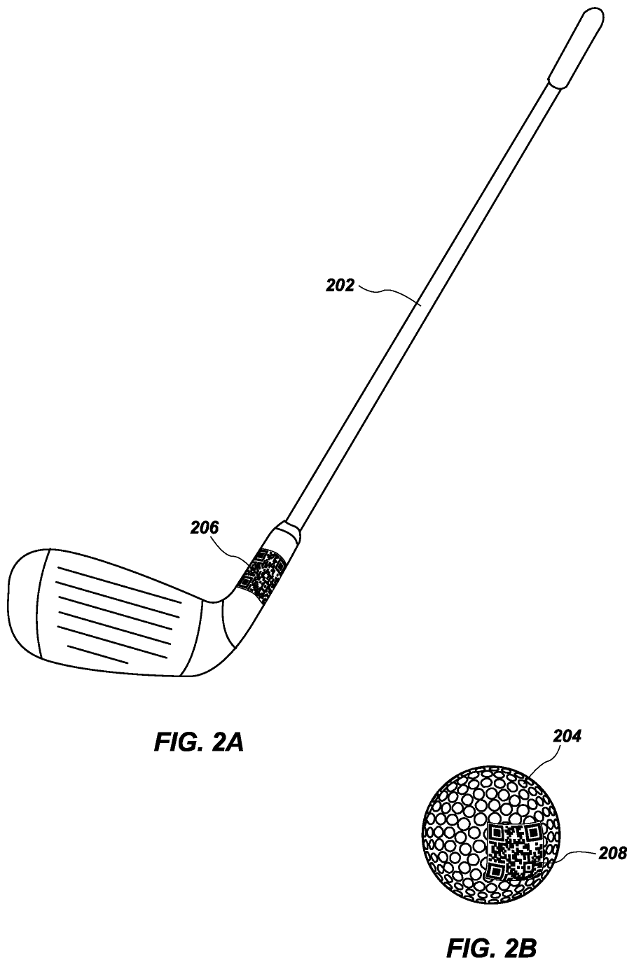

FIG. 2A depicts an example piece of sports equipment in the form of a golf club having a marking 206 configured to identify the golf club. In some embodiments the marking 206 may be located on the hosel of a golf club 202 (i.e., the portion of a golf club 202 where the shaft is connected to the head), and may be oriented to face toward, or otherwise be detectable by, the first sensor 104 (see FIG. 1) when the golf club 202 is held to strike a ball and the head of the golf club 202 is proximate to the ground. In some embodiments, marking 206 may identify at least one characteristic of a golf club 202. For example, marking 206 may identify at least one of golf club type (e.g., five iron, sand wedge, driver), manufacturer, make, model, year, shaft length, grip type, material, flex, or mass.

FIG. 2B shows yet another example piece of sports equipment in the form of a golf ball. Marking 208 may be configured to at least partially identify a golf ball 204. Furthermore, Marking 208 may also identify one or more characteristics of a golf ball 204 such as, for example, at least one of mass, weight, elasticity, ball type, dimensions, color, material, manufacturer, make, model, or year. While FIGS. 2A and 2B show sports equipment such as a golf club 202 and a golf ball 204, respectively, the scope of this disclosure it not limited to golf equipment, and sports simulators with equipment identifiers may be utilized to identify and generate simulations for virtually any piece of sports equipment including any type of sports related ball is contemplated.

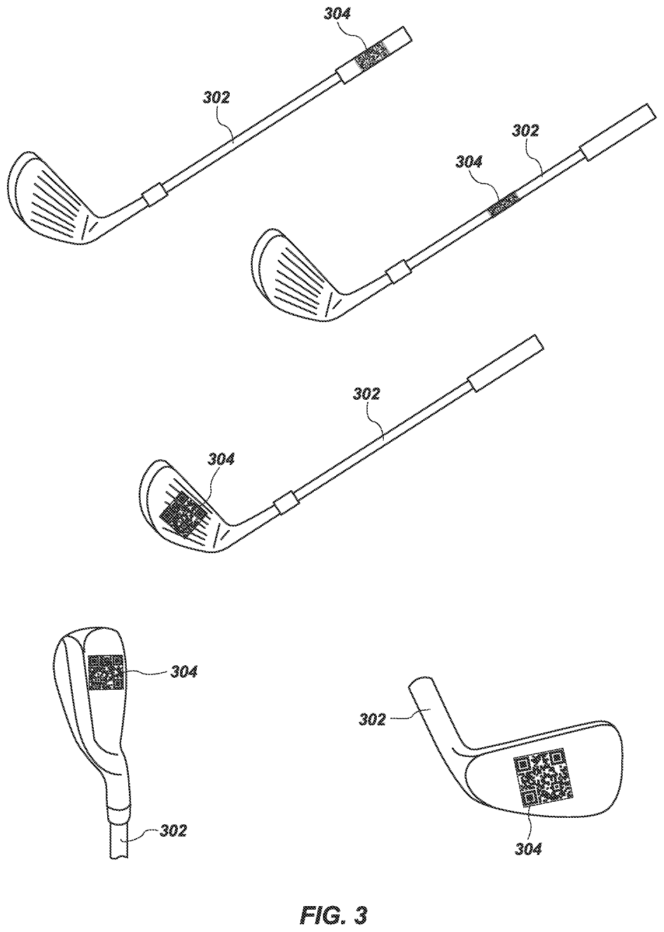

FIG. 3 illustrates possible configurations for a marking 304 on a piece of sports equipment, such as golf club 302. The marking 304 may, in some embodiments, be located on the handle, shaft, body, head, face, base, or other portion of a piece of sports equipment. As shown in FIG. 3, when the piece of sports equipment is a golf club, the marking 304 may be located on a handle of the golf club, on the shaft of the golf club, on the face of the golf club head, on the backside of the golf club head, and/or on the bottom of the golf club head. Furthermore, the marking 304 may be located anywhere on golf club 302 so long as the marking is within detectable range of a sensor (e.g., first sensor 104) in the course of the regular use of a sports simulator system (e.g., sports simulator system 100). Though the location of the marking is discussed in connection with FIG. 3 in relation to a golf club 302, this disclosure is not so limited. For example, the marking may be located at any location on a piece of sports equipment so long as the marking is in view of a sensor (e.g., first sensor 104) when a user plays a simulated sport using the sports simulator system 100.

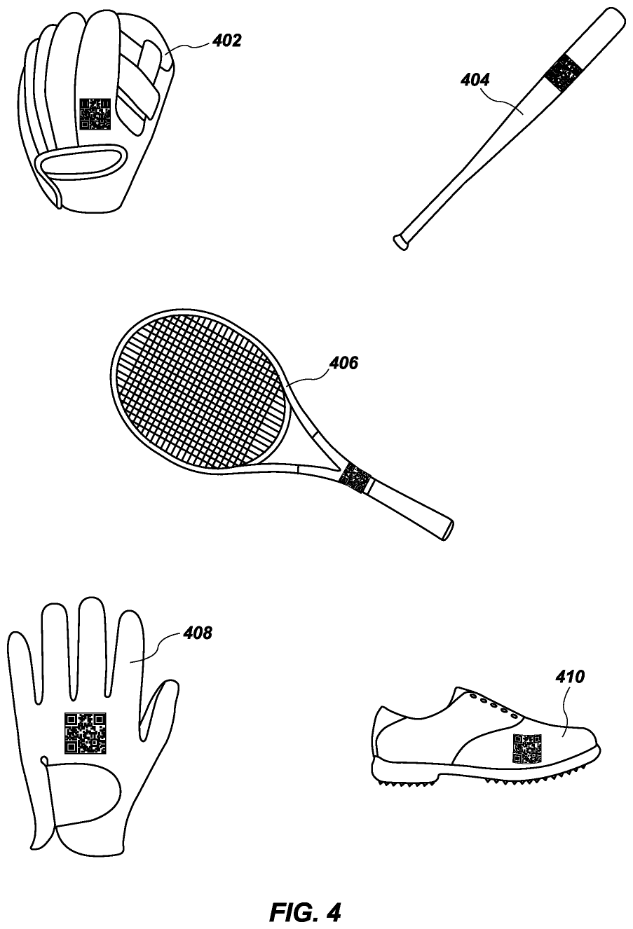

FIG. 4 depicts non-limiting examples of potential sports equipment for use in a sports simulator system (e.g., sports simulator system 100) including a baseball mitt 402, baseball bat 404, tennis racket 406, golfing glove 408, and golfing shoe 410. Each piece of sports equipment may, in some embodiments, have a unique marking relative to the type or model of sports equipment. For example, a particular model of baseball bat 404 may have a marking unique to that particular model indicating certain characteristics of that particular model of baseball bat 404. However, a different model of baseball bat, even when made by the same manufacturer, may have a different marking to indicate characteristics of the different model. In some embodiments, each piece of sports equipment may receive a unique marking even between pieces of sports equipment of the same model. In some embodiments markings may be uniform for a class, type, or manufacturing run of sports equipment.

FIG. 5 depicts non-limiting examples of potential markings 500 for use on pieces of sports equipment in a sports simulator system (e.g., sports simulator system 100) including a QR code 502, a reflective infrared (IR) signature 504, and a dot IR signature 506. A marking may be either supported on or embedded within a material of the piece of sports equipment. A marking may be milled, stamped, engraved, or scribed into a piece of sports equipment. Furthermore, a marking may be infrared ink directly applied to a piece of sports equipment. Regardless of the form a marking takes, a marking may be invisible to the human eye and only visible using a sensor (e.g., first sensor 104) in some examples. In other examples, the marking may be visible to the human eye as well as detectable using a sensor (e.g., first sensor 104). In some embodiments, a marking may be retrofitted onto a piece of sports equipment by, for example, placing the marking on a small, optionally transparent sticker and applying the sticker to a piece of sports equipment. In some embodiments, a marking may identify a unique id that may be used by a sports simulator system to verify the identity of a user. A marking may include a pattern of dots. In some embodiments, when a marking is a pattern of dots, the dots may correlate to a characteristic of the piece of sports equipment. For example, when the piece of sports equipment is a golf club, a marking comprising a pattern of dots may have five dots to denote that the golf club is a five iron club.

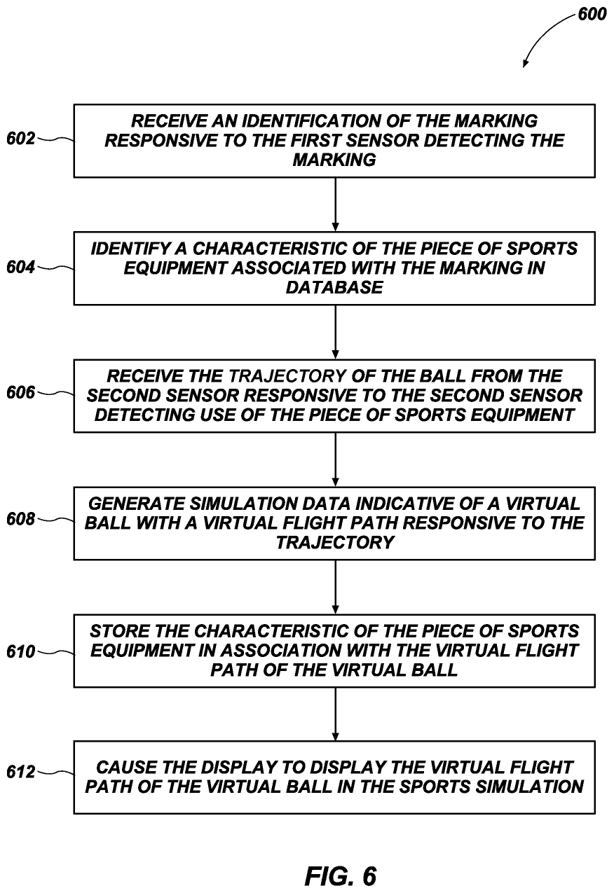

FIG. 6 is a flowchart illustrating an operation of the sports simulator system 100 performed by a processor executing instructions stored on a computer-readable storage medium. At operation 602, the sports simulator system 100 receives an identification of a marking responsive to the first sensor 104 detecting the marking. At operation 604, the sports simulator system 100 identifies a characteristic of the piece of sports equipment associated with the marking in a database. In some embodiments where the piece of sports equipment is a golf club, the sports simulator system 100, may identify one or more characteristics including golf club type, manufacturer, make, model, year, shaft length, flex, grip type, material, or mass. Furthermore, in some embodiments the sports simulator system 100 may identify one or more characteristics of a piece of sports equipment including sports balls based on detected surface detail of the piece of sports equipment. For example, the sports simulator system 100 may identify a golf ball responsive to detecting a logo on the ball, detecting the dimple pattern on the surface of the golf ball, or detecting another marking on or embedded within the golf ball. At operation 606, the sports simulator system 100 receives or determines the trajectory of the ball from the second sensor 106 responsive to the second sensor 106 detecting use of the piece of sports equipment to interact with the ball. At operation 608, the sports simulator system 100 generates simulation data indicative of a virtual ball with a virtual flight path responsive to the trajectory. At operation 610, the sports simulator system 100 stores the characteristic of the piece of sports equipment in association with the virtual flight path of the virtual ball. In operation 612, the sports simulator system 100 causes the display 108 to display the virtual flight path of the virtual ball in the sports simulation.

The sports simulator system 100 may accept a user identification for a user of the piece of sports equipment and store the user identification in association with the virtual flight path of the virtual ball. In some embodiments a user may input a user identification manually using an input terminal of the sports simulator system 100. The sports simulator system 100 may automatically associate an identified piece of sports equipment (e.g., sports equipment 102) with a user when the piece of sports equipment is identified after the sports simulator system 100 has accepted a user identification. The sports simulator system 100 may also automatically accept a user identification responsive to identifying a piece of sports equipment already associated with a user identification.

The sports simulator system 100 may accept an equipment identification of the piece of sports equipment and store the equipment identification in association with the virtual flight path of the virtual ball. In some embodiments, a user may manually input an equipment identification using an input terminal of the sports simulator system 100 and associate the equipment with one or more user identified virtual flight paths of the virtual ball. For example, when the sports simulator system 100 is a golf simulator, if a user has played a simulated game of golf but no equipment has been identified by the sports simulator system 100, the user, at the end of the game, may manually enter one or more equipment identifications to associate with the virtual flight paths of the virtual ball that occurred during the completed game of golf. In some embodiments, when the user has completed a game on the sports simulator system 100 and no equipment identification has been accepted for the game session, the sports simulator system 100 may generate a prompt to the display (e.g., display 108) asking the player to enter an equipment identification to associate with the virtual paths of the virtual ball that occurred during the game.

In some embodiments where the piece of sports equipment (e.g., sports equipment 102 of FIG. 1) is a golf club and the ball (e.g., ball 112 of FIG. 1) is a golf ball, the sports simulator system 100 may receive characteristics of an interaction between the piece of sports equipment and the ball including at least one of club head speed, ball flight trajectory, ball travel distance, club face angle, ball flight velocity, ball flight acceleration, ball deformation, or ball spin. The sports simulator system 100 may then store the identified characteristic of the piece of sports equipment in association with the received characteristics of an interaction between the piece of sports equipment and the ball.

The sports simulator system 100 may determine whether the virtual flight path of the virtual ball underperforms relative to other virtual flight paths of other virtual balls for pieces of sports equipment having characteristics other than the characteristics of the piece of sports equipment detected by the first sensor (e.g., first sensor 104 of FIG. 1) and cause the display (e.g., display 108) to display a recommendation to utilize a different piece of sports equipment selected to improve performance. For example, the sports simulator system 100 may compare the virtual flight path to an average or best virtual flight path achieve utilizing the same piece of sports equipment or in similar sports situations in terms of distance, speed, path relative to a goal (e.g., direction relative to golf hole, direction relative to play area), or other metrics, and determine whether a percent deviation from the average or best virtual flight path is within a standard deviation when compared to all virtual flight paths stored in, or accessible to, the sports simulator system 100. In some embodiments, the sports simulator system 100 may cause the display to display a virtual store front presenting an offer to purchase a recommended piece of sports equipment. Furthermore, the sports simulator system 100 may recommend certain sports equipment pairings responsive to determining whether the virtual flight path of the virtual ball underperforms relative to other virtual flight paths of other virtual balls. For example, the sports simulator system 100 may recommend pairing certain golf clubs with certain golf gloves, golf balls, and/or golf shoes to improve performance.

The sports simulator system 100 may store the characteristics of multiple pieces of sports equipment with a virtual flight path responsive to a trajectory as well as with a user identification. For example, the sports simulator system 100 may automatically identify characteristics of a golf club, a golf ball, golf gloves, and golf shoes being used simultaneously for an associated virtual flight path or user identification. The sports simulator system 100 may then store each of the identified characteristics of the golf club, golf ball, golf gloves, and golf shoes in association a corresponding virtual flight path of a virtual ball or user identification. In some embodiments, the sports simulator system 100 may generate recommended combinations of pieces of sports equipment based on stored combinations of sports equipment of prominent or popular users, such as professional golfers. Additionally, the sports simulator system 100 may cause the display to display a virtual store front featuring preferred or recommended combinations of pieces of sports equipment. For example, if the sports simulator system 100 identifies a characteristic of a piece of sports equipment (e.g., a model of a golf club), the sports simulator system 100 may then cause the display to display a virtual store front showing other pieces of sports equipment frequently combined with the piece of sports equipment by other users or by verified professional sports personalities.

The sports simulator system 100 may determine whether the virtual flight path of the virtual ball is expected given the trajectory and characteristic of the piece of sports equipment. For example, the sports simulator system 100 may determine that a distance traveled, trajectory, speed, or other characteristics of the virtual flight path is within one standard deviation of an average flight path for balls recorded from interactions with the piece of sports equipment to determine whether the virtual flight path is expected. The sports simulator system 100 may then request verification of the piece of sports equipment when the virtual path is not expected and store an indication that the virtual flight path of the virtual ball is not expected given the trajectory and the characteristic of the piece of sports equipment in association with the virtual flight path of the virtual ball when the virtual flight path is not expected.

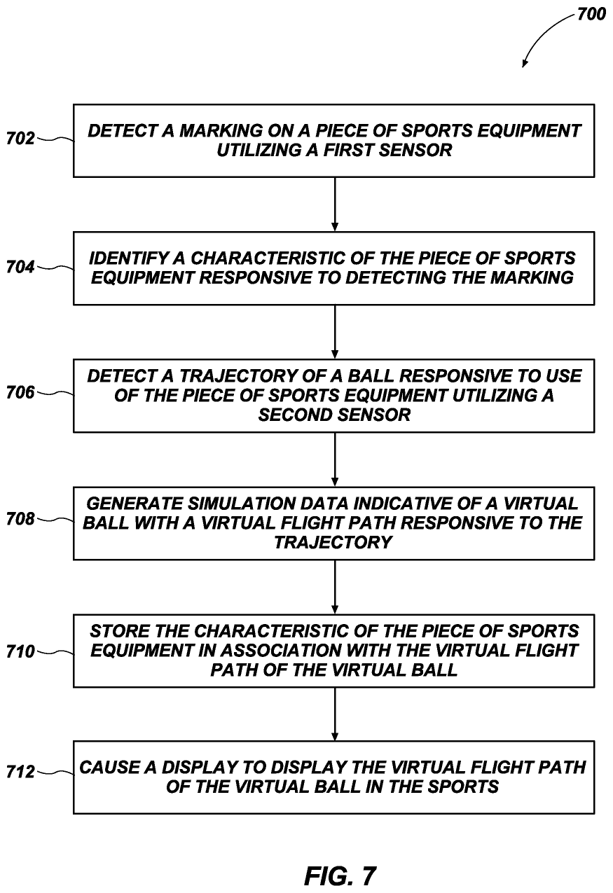

FIG. 7 is a flowchart illustrating a method 700 for simulating sports equipment performance. In some embodiments, method 700 may be performed by a device or system, such as sports simulator system 100 (see FIG. 1). In operation 702, method 700 detects a marking on a piece of sports equipment (e.g., sports equipment 102 of FIG. 1) utilizing a first sensor (e.g., first sensor 104 of FIG. 1). In operation 704, method 700 identifies a characteristic of the piece of sports equipment responsive to detecting the marking. In operation 706, method 700 detects a trajectory of a ball responsive to the use of the piece of sports equipment utilizing a second sensor (e.g., second sensor 106 of FIG. 1). In operation 708, method 700 generates simulation data indicative of a virtual ball with a virtual flight path responsive to the trajectory. In operation 710 of method 700, method 700 stores the characteristic of the piece of sports equipment in association with the virtual flight path of the virtual ball. In operation 712, method 700 causes a display (e.g., display 108 of FIG. 1) to display the virtual flight path of the virtual ball in the sports.

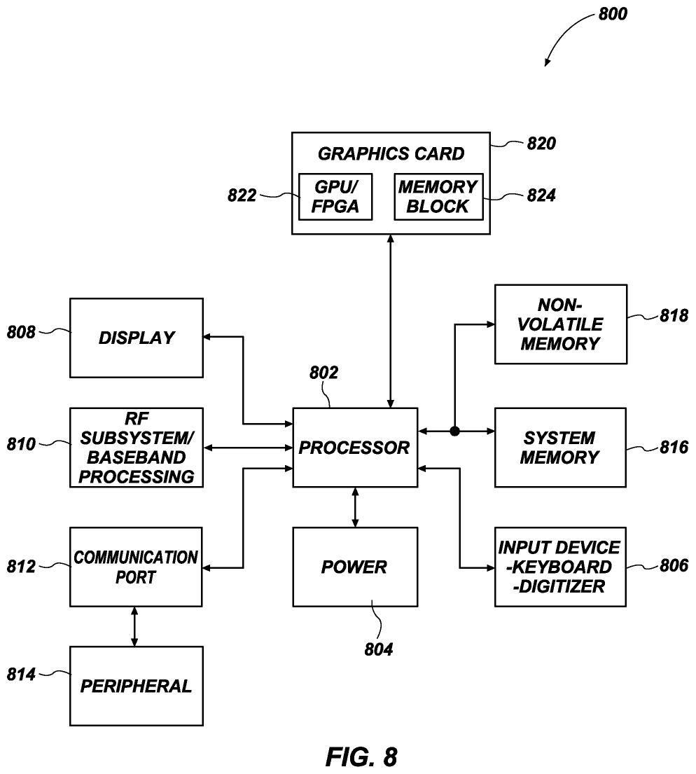

FIG. 8 is a block diagram of an electronic system 800 included in one or more systems of this disclosure. For example, the electronic system 800 may be any of a variety of types, such as a computer, tablet, cellular phone, smartphone, control circuit, or other electronic device. The electronic system 800 may include one or more processors 802, such as a microprocessor, field-programmable gate array (FPGA), or combination of a microprocessor and FPGA, to control the processing of system functions and requests in the electronic system 800. In some embodiments the electronic system 800 is incorporated into a sports simulator system 100 of this disclosure.

The electronic system 800 may include a power supply 804 in operable communication with the processor 802. For example, if the electronic system 800 is a portable system, the power supply 804 may include one or more of a fuel cell, a power scavenging device, permanent batteries, replaceable batteries, and/or rechargeable batteries. The power supply 804 may also include an AC adapter; therefore, the electronic system 800 may be plugged into a wall outlet, for example.

Various other devices may be coupled to the processor 802 depending on the functions that the electronic system 800 performs. For example, a user interface 806 may be coupled to the processor 802. The user interface 806 may include input devices such as buttons, switches, a keyboard, a light pen, a mouse, a digitizer and stylus, a touch screen, a voice recognition system, a microphone, or a combination thereof. A display 808 may also be coupled to the processor 802. The display 808 may include an LCD display, an SED display, a CRT display, a DLP display, a plasma display, an OLED display, an LED display, a three-dimensional projection, an audio display, a projection screen display, or a combination thereof. Furthermore, an RF sub-system/baseband processor 810 may also be coupled to the processor 802. The RF sub-system/baseband processor 810 may include an antenna that is coupled to an RF receiver and to an RF transmitter (not shown). A communication port 812, or more than one communication port 812, may also be coupled to the processor 802. The communication port 812 may be adapted to be coupled to one or more peripheral devices 814, such as a modem, a printer, a computer, a scanner, or a camera, or to a network, such as a local area network, remote area network, intranet, or the Internet, for example.

The processor 802 may control the electronic system 800 by implementing software programs stored in one or more memory devices 816, 818 (also referred to herein as “memory device 816” and “memory device 818”). The software programs may include an operating system, database software, drafting software, word processing software, media editing software, or media playing software, for example. The memory device(s) 816, 818 are operably coupled to the processor 802 to store and facilitate execution of various programs. For example, the processor 802 may be coupled to system memory 816, which may include one or more of spin torque transfer magnetic random access memory (STT-MRAM), magnetic random access memory (MRAM), dynamic random access memory (DRAM) (e.g., synchronous DRAM (SDRAM) conforming with a double data rate (DDR) and/or graphics DDR (GDDR) standard (DDR4, DDR5, DDR6)), static random access memory (SRAM), racetrack memory, and other known memory types. The system memory 816 may include volatile memory, non-volatile memory, or a combination thereof. The system memory 816 is typically large so that it can store dynamically loaded applications and data.

The processor 802 may also be coupled to memory device, which is a non-volatile memory and may be referred to herein as “non-volatile memory 818,” which is not to suggest that system memory 816 is necessarily volatile. The non-volatile memory 818 may include one or more of STT-MRAM, MRAM, read-only memory (ROM) such as an EPROM, resistive read-only memory (RROM), and flash memory to be used in conjunction with the system memory 816. The size of the non-volatile memory 818 is typically selected to be just large enough to store any necessary operating system, application programs, and fixed data. Additionally, the non-volatile memory 818 may include a high-capacity memory such as disk drive memory, such as a hybrid-drive including resistive memory or other types of non-volatile solid-state memory, for example.

In some embodiments, the electronic system 800 may include a graphics subsystem, such as a graphics card 820, connected to the processor 802. For example, each of the graphics card 820 and the processor 802 may be connected to, and supported on, a motherboard in their respective sockets (e.g., a peripheral component interconnect express (PCIe) socket for the graphics card 820, a CPU socket for the processor 802). The graphics card 820 may include its own processing device, such as a graphics processing unit (GPU) or FPGA 822. The GPU or FPGA 822 may be configured to, and may be a dedicated device for, processing graphics-related tasks to accelerate the creation of images in a frame buffer intended for output to the display 808. The graphics card 820 may also include a memory bank, such as, for example, a graphics memory block 824, which may include one or more high-speed memory devices connected to the GPU or FPGA 822 and configured to store and facilitate acceleration of graphics-related data. More specifically, the graphics memory block 824 may include one or more banks of devices configured as dynamic random access memory (DRAM) (e.g., synchronous DRAM (SDRAM) conforming with a double data rate (DDR) and/or graphics DDR (GDDR) standard (GDDR5, GDDR6, GDDR7)).

The illustrations presented herein are not meant to be actual views of any particular method, system, device, or structure, but are merely idealized representations that are employed to describe the examples of this disclosure. In some instances similar structures or components in the various drawings may retain the same or similar numbering for the convenience of the reader; however, the similarity in numbering does not necessarily mean that the structures or components are identical in size, composition, configuration, or any other property.

This description may include examples to help enable one of ordinary skill in the art to practice the disclosed examples. The use of the terms “illustrative,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of this disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement this disclosure unless specified otherwise herein. Elements, circuits, and functions may be shown in block diagram form in order not to obscure this disclosure in unnecessary detail. Conversely, specific implementations shown and described are illustrative only and should not be construed as the only way to implement this disclosure unless specified otherwise herein. Additionally, block definitions and partitioning of logic between various blocks is illustrative of a specific implementation. It will be readily apparent to one of ordinary skill in the art that this disclosure may be practiced by numerous other partitioning solutions. For the most part, details concerning timing considerations and the like have been omitted where such details are not necessary to obtain a complete understanding of this disclosure and are within the abilities of persons of ordinary skill in the relevant art.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration.

The examples herein may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, at least 99% met, or 100% met.

As used in this disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in this disclosure may be implemented as objects or processes that execute on the computing system (e.g., as separate threads). While some of the system and methods described in this disclosure are generally described as being implemented in software (stored on and/or executed by general purpose hardware), specific hardware implementations or a combination of software and specific hardware implementations are also possible and contemplated.

As used in this disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in this disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While this disclosure has been described herein with respect to certain illustrated examples, those of ordinary skill in the art will recognize and appreciate that this invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A sports simulator, comprising:
a piece of sports equipment bearing a marking configured to at least partially identify the piece of sports equipment;
a first sensor configured to automatically detect the marking;
a second sensor configured to detect a trajectory of a ball;
a display configured to display a sports simulation;
a processor; and
a computer-readable storage medium storing instructions thereon that, when executed by the processor, cause the sports simulator to:
receive an identification of the marking responsive to the first sensor detecting the marking;
identify a characteristic of the piece of sports equipment associated with the marking in a database responsive to receiving the identification of the marking;
receive the trajectory of the ball from the second sensor responsive to the second sensor detecting use of the piece of sports equipment to interact with the ball;
generate simulation data indicative of a virtual ball with a virtual flight path responsive to the trajectory;
store the characteristic of the piece of sports equipment in association with the virtual flight path of the virtual ball; and
cause the display to display the virtual flight path of the virtual ball in the sports simulation.

2. The sports simulator of claim 1, wherein the instructions stored on the computer-readable storage medium, when executed by the processor, cause the sports simulator to:
accept a user identification for a user of the piece of sports equipment; and
store the user identification in association with the virtual flight path of the virtual ball.

3. The sports simulator of claim 1, wherein the instructions stored on the computer-readable storage medium, when executed by the processor, cause the sports simulator to:
determine whether the virtual flight path of the virtual ball underperforms relative to other virtual flight paths of other virtual balls for pieces of sports equipment having characteristics other than the characteristic of the piece of sports equipment detected by the first sensor; and
cause the display to display a recommendation to utilize a different piece of sports equipment selected to improve performance.

4. The sports simulator of claim 1, wherein the instructions stored on the computer-readable storage medium, when executed by the processor, cause the sports simulator to identify the characteristic of the piece of sports equipment as at least one of golf club type, manufacturer, make, model, year, shaft length, grip type, material, or mass when the piece of sports equipment is a golf club.

5. The sports simulator of claim 1, wherein the second sensor is configured to detect at least one of club head speed, ball flight trajectory, ball travel distance, club face angle, ball flight velocity, ball flight acceleration, and ball deformation when the piece of sports equipment is a golf club and the ball is a golf ball.

6. The sports simulator of claim 1, wherein the first sensor comprises an infrared (IR) camera.

7. The sports simulator of claim 1, wherein the marking comprises a material reflective infrared radiation supported on or embedded within a material of the piece of sports equipment.

8. The sports simulator of claim 1, wherein the marking is located on a hosel of a golf club when the piece of sports equipment is the golf club.

9. The sports simulator of claim 1, wherein the marking comprises a pattern of dots.

10. The sports simulator of claim 1, wherein the second sensor comprises a high-speed camera.

11. The sports simulator of claim 1, wherein the instructions stored on the computer-readable storage medium, when executed by the processor, cause the sports simulator to:
accept an equipment identification of the piece of sports equipment; and
store the equipment identification in association with the virtual flight path of the virtual ball.

12. The sports simulator of claim 1, comprising the ball bearing another marking configured to at least partially identify the ball.

13. The sports simulator of claim 1, wherein the instructions stored on the computer-readable storage medium, when executed by the processor, cause the sports simulator to:
determine whether the virtual flight path of the virtual ball is expected given the trajectory and the characteristic of the piece of sports equipment;
request verification of the piece of sports equipment when the virtual flight path is not expected; and
store an indication that the virtual flight path of the virtual ball is not expected given the trajectory and the characteristic of the piece of sports equipment in association with the virtual flight path of the virtual ball when the virtual flight path is not expected.

14. A method for simulating sports equipment performance, comprising:
detecting a marking on a piece of sports equipment utilizing a first sensor;
identifying a characteristic of the piece of sports equipment responsive to detecting the marking;
detecting a trajectory of a ball responsive to use of the piece of sports equipment utilizing a second sensor;
generating simulation data indicative of a virtual ball with a virtual flight path responsive to the trajectory;
storing the characteristic of the piece of sports equipment in association with the virtual flight path of the virtual ball; and
causing a display to display the virtual flight path of the virtual ball in the sports.

15. The method of claim 14, comprising:
accepting a user identification for a user of the piece of sports equipment; and
storing the user identification in association with the virtual flight path of the virtual ball.

16. The method of claim 14, comprising:
determining whether the virtual flight path of the virtual ball underperforms relative to other virtual flight paths of other virtual balls for pieces of sports equipment having characteristics other than the characteristic of the piece of sports equipment detected by the first sensor; and
causing the display to display a recommendation to utilize a different piece of sports equipment selected to improve performance.

17. The method of claim 14, wherein identifying the characteristic of the piece of sports equipment comprising at least one at least one of golf club type, manufacturer, make, model, year, shaft length, grip type, material, or mass when the piece of sports equipment is a golf club.

18. The method of claim 14, wherein detecting the marking on the piece of sports equipment comprises detecting a material reflective infrared radiation supported on or embedded within a material of the piece of sports equipment.

19. The method of claim 14, comprising:
accepting an equipment identification of the piece of sports equipment; and
storing the equipment identification in association with the virtual flight path of the virtual ball.

20. The method of claim 14, comprising:
determining whether the virtual flight path of the virtual ball is expected given the trajectory and the characteristic of the piece of sports equipment;
requesting verification of the piece of sports equipment when the virtual flight path is not expected; and
storing an indication that the virtual flight path of the virtual ball is not expected given the trajectory and the characteristic of the piece of sports equipment in association with the virtual flight path of the virtual ball when the virtual flight path is not expected.
